(19) United States
(12) Patent Application Publication
(10) Pub. No.: US 2005/0280257 A1
(43) Pub. Date: Dec. 22, 2005

(54) Apparatus and method for advertising

(76) Inventors: Jay Nijjer, Bellevue, WA (US); Beverley Elizabeth Alexandra Ward, Edgbaston (GB); Lee White, Kirkland, WA (US)

Correspondence Address: BLACK LOWE & GRAHAM, PLLC, 701 FIFTH AVENUE, SUITE 4800, SEATTLE, WA, 98104, US

(21) Appl. No.: 11/099,213

(22) Filed: Apr. 4, 2005

Related U.S. Application Data
(60) Provisional application No. 60/559,587, filed on Apr. 5, 2004.

(51) Int. Cl. B42D 5/04

(52) U.S. Cl. 283/2

(57) ABSTRACT

An advertising method comprising having one or more advertisement messages for placing on a medication reminder card; and forming the medication reminder card to create visible means for advertising the one or more messages and reinforcing medication usage compliance. The advertisement messages are any message capable of being visibly placed upon the medication reminder card. The medication reminder card formed to create visible means for advertising the one or more messages reinforces medication usage compliance through one or more visible means.

### PRIORITY CLAIM

This application claims priority to and incorporates by reference U.S. Provisional Patent Application No. 60/559,587 filed Apr. 5, 2004 as if fully disclosed herein.

### FIELD OF THE INVENTION

This invention relates generally to a system and method to deliver advertising, and more specifically, to a system and method of advertising one or more messages on a medication reminder card that is formed to create visible means for reinforcing medication usage compliance.

### BACKGROUND OF THE INVENTION

Current models of direct-to-consumer advertising (DTCA) do not offer consumer advertisers a cost-effective method to advertise their goods and services, for example medications and other relevant products, while at the same time effectively promoting compliance with medication regimens. Currently, for example, prescription drug promotion by pharmaceutical firms takes two forms: the promotion aimed at doctors, and advertisements directed to consumers. Advertisements toward doctors include visits by pharmaceutical representatives, free samples, and advertisements in medical journals, displays and presentations at professional meetings. Such promotions were the only form of advertisement for prescription drugs until 1981, when drug companies expanded their marketing strategies to include direct advertising to patients. Although the most familiar form of promotion toward consumers is targeted to the general population via popular media, such as television or magazines, DTCA is also commonly conveyed directly to patients through web sites, help-lines, personalized mailings, targeted web-advertisement, and in-doctor-office or in-pharmacy information pamphlets. There are three types of allowed DTCA: “health seeking advertisement,” “reminder advertisement,” and “product-specific (or product claim) advertisement.” A health seeking advertisement informs the consumers about the existence of a treatment for some particular condition, while encouraging them to consult their doctors for more information. This type of advertisement does not refer to a specific product to be used in the treatment of the condition. In contrast, a reminder advertisement mentions the name of a drug and the drug company, but omits the drug indication. Product-specific advertisement reveals both the drug's name and the indication. Generally, the three types of DTCA require significant and expensive monetary and human resources. Additionally, these types of advertising allow only for time-shortened exposure to the advertisement message, for example during short 30-second television and radio ads, thus creating the need for expensive repetitive message placements to ensure value for the advertisement. Furthermore, these advertisements do not include any method to promote medication compliance, a serious financial and health issue in the healthcare industry.

Concerns have grown in the medical profession about high rates of patient noncompliance with prescription drug regimens. Noncompliance is clearly a serious problem: a recent study indicates that 70% of patients do not comply with drug prescriptions, resulting in annual losses of $170 billions in the U.S. Noncompliance is widely recognized to be a serious public health problem. The annual cost of noncompliance is believed to reach up to $170 billions in the U.S., which would exceed the expenses in prescription medications. Noncompliance also has serious health implications: it has been estimated that up to 11.4% of admissions to hospital resulted from failure to comply with drug regimen. Another study suggests that 125,000 cardiovascular deaths should be blamed annually in the U.S. on noncompliance. In fact, the American Hearth Association has recently stated that “the cost of noncompliance in terms of human life and money is shocking”, and has made prescription drug compliance one of the Association's key health issues.

Current art teaches various methods for encouraging compliance with medication regimens, but do not teach that in combination with advertising. Exemplary of the art includes, for example, the Welles Patent (U.S. Pat. No. 6,464,506), which teaches a medication compliance organizer that takes the form of a magnetized panel that may be conveniently mounted on the front of an appliance such as a refrigerator, or alternatively conventionally hung on a wall or other suitable surface. The organizer includes a plurality of day, time based containers for organizing, and releasably holding the medications, typically four vials in vertical columns for each day of the week, one for each prescription time interval, i.e., morning, noon, evening and bedtime. Another example is the ColDepietro et al., Patent (U.S. Pat. No. 6,273,260), that teaches a packaging system for storing and dispensing individual doses of medication on prescribed days, the packaging system comprising a series of sheets adapted to fold over each other with doses of medication removably held thereon. A plurality of labels are held on at least one of the sheets, each label corresponding to one dose of medication, each of the labels being adapted to be removed from one of the sheets and applied to a calendar to thereby serve as a reminder of the day on which the corresponding individual dose of medication is to be taken. Yet another example is the Luoma Patent (U.S. Pat. No. 6,032,609) that teaches a combination of a bottle used to contain pharmaceutical products and a permanent indicia system having a plurality of indicators operated sequentially by an irreversible physical act producing a permanent dosage recording indicator, the exposure of a plurality of said indicators showing a cumulative dosage record. Humphrey et al., (U.S. Pat. No. 4,883,180) teaches a coding system for matching specific consumption times and for appropriate medicines stored in a medical container which includes an open-ended container having a removable cap closure and a label imprinted with the specific times for taking of the medicine. The cap and label are identically colored to represent the number of times that the medicine is to be taken per day. The label is further coded with a selected number of raised identification dots or nubs to represent the number of times that the medicine is to be taken per day. This small label is attached by the pharmacist in addition to the regular label per customer request.

While the current state of the art teaches some form of reminder method or system for medication dosage compliance, none teach the specific devices or combination of devices disclosed herein, and none teach the use of those reminder devices, methods or systems in combination with a method or system to advertise. Thus, there exists a need to cost-effectively advertise a broad array of advertisements in a way that commands the persistent attention of the target audience for maximum retention and efficacy. There also exists a need to improve medication compliance. There also exists a need for harnessing improved medication compliance tools and devices as a novel and more effective medium, or new channel for advertising. There also exists a need for more cost-effective targeting of advertisements.

### SUMMARY OF THE INVENTION

Preferred embodiments of the instant invention comprise a device, and/or a method to place or deliver advertising adjacent to a calendar-based medication reminder card established for a medical regimen to a user while ascertaining and/or documenting compliance to the medical regimen by the user, preferably while the user has the advertisement in view. Preferably the device and/or method to advertise includes placing one or more messages in view of the user, preferably adjacent to or in association with the calendar-based medication reminder card. Preferably the reminder card is configured to document regimen compliance by encouraging the user to record the scheduled medication usage.

Preferably the medication reminder card creates a visible means for advertising at least one or more messages and reinforcing medication usage compliance. Generally, the medication reminder card provides a printed dosage reminder of a time-based medical regimen or other health related regimen that is adjacently positioned to at least one advertisement within the field of view of the user. The reminder card and is designed to encourage user interaction to document or record compliance with the medical regimen and so promote extended and/or repeated viewing of the advertisement while regimen compliance is being documented by the user or others. Repetitive and/or prolonged viewing of adjacent advertisement messages insures that the adjacent advertisements are routinely and/or repeatedly viewed for extended periods to convey the advertisement content to the user.

Preferably the medical reminder card includes single page or multi-page calendars or other time-based documents, each calendar or time-based document preferably having time subdivisions containing at least one modifiable material on the surface of the time subdivisions. The at least one modifiable material represents an individual or group of medications to be taken. The shape, color, and number of modifiable materials may be varied by time subdivision to represent single dose or multi-dose regimens of single drug or multi-drug combinations or other variables. Preferably compliance with the medical regimen is indicated when the user modifies the modifiable material in accord with the schedule of the medication reminder card.

Preferably the modifiable material may include scratch-off coatings that may be color-coded or shape-coded in a likeness similar to the medication of the regimen. Preferably the scratch-off coatings represent an individual medication or a group of medications that are scratched-off when the user complies with the medication schedule of the regimen. Alternatively the modifiable material further includes removable peel-off tabs. The peel-off tabs may similarly be color-coded or shaped-coded and represent single or multi-drug combinations and doses. Alternatively the modifiable material further provides surfaces for displaying and receiving numerical and text-based symbols as aids to document regimen compliance. Alternatively, the time subdivisions may include boxes to be checked or marked-off as dosages are taken. Alternative embodiments employ combinations of the foregoing.

The medical reminder card may also be configured for documenting interaction for non-medical purposes, for example, scheduled automobile repair.

### DETAILED DESCRIPTION OF THE PARTICULAR EMBODIMENTS

The advertising method of a preferred embodiment of the present invention comprises having one or more advertisement message for placing on a medication reminder card and forming the medication reminder card to create visible means for advertising the one or more messages and reinforcing medication usage compliance. Preferably the advertising method is achieved using an advertising device discussed in detail below.

In general, the advertising device comprises a surface to receive an advertising message and at least one calendar configured to encourage a user to timely reply to a regimen while information in the advertising message is in the field of view of the user. One preferred embodiment includes a surface having a first section to receive an advertising message in view of the user, and a second section having a surface to receive another advertising message and also in view of the user. There may be an axis between the first and second sections so that sections may be pivotable or otherwise foldable. Onto either the first or second sections a calendar is affixed or otherwise nearby or adjacent. The calendar includes time-based divisions that are configured to remind the user to comply with a regimen. The time-based divisions are preferably made of modifiable material, such that when the user is prompted to comply in a timely manner with the regimen, information from the advertising messages are viewed by the user. Other embodiments may include one section or more than two sections, such that at least one section receives the calendar and one or more sections are adapted to receive advertising messages. Other preferred embodiments would allow more than one calendar. For example, one calendar affixed to one section for a regimen to stop smoking, and another calendar affixed to another section having a regimen to alter eating habits or other behaviors.

In alternate embodiments, the advertisement messages can be any type of advertisement capable of being reproduced or placed upon on a medication reminder card. Advertisement messages in one preferred embodiment include the advertisement of brand names, campaign slogans, product promotions, and/or any other message capable of being reproduced on the medication reminder card. While the currently preferred embodiment is described as including advertising related to the medical and pharmaceutical industries, certain alternate embodiments include any type of advertising related to any industry desiring a cost-effective method of presenting one or more advertising messages to consumers.

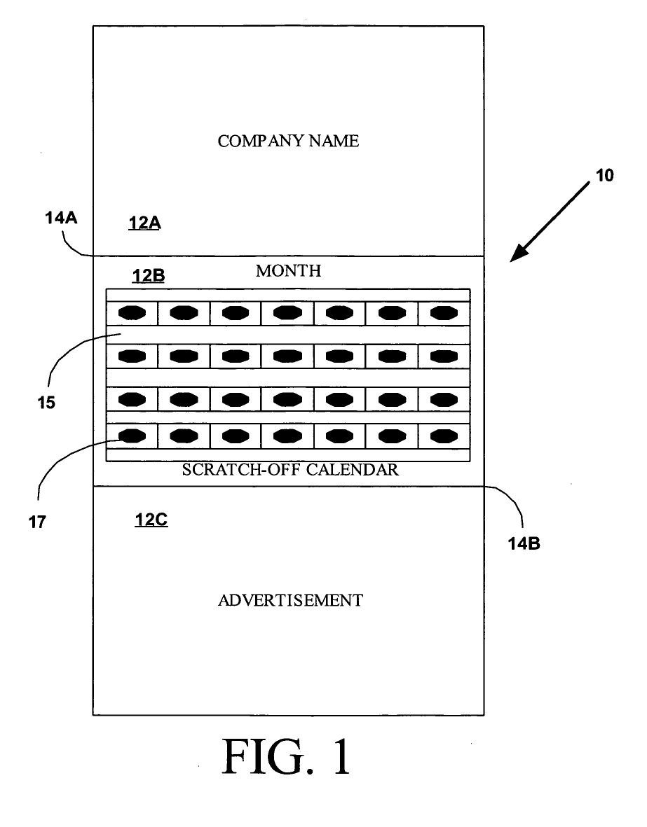

FIG. 1 is an illustrative view of a preferred embodiment of the present invention. In another preferred embodiment, a medication reminder card 10 is formed to create visible means for advertising the one or more messages and reinforcing medication usage compliance. The medication reminder card 10 includes a viewing surface on any of one or more sides or sections of the medication reminder card 10. The viewing surface of a first section 12A can be configured for the placement of the name of the person or entity sponsoring or having affiliation with the advertisement. While the viewing surface of a second section 12B could be anywhere on the card, preferably it is substantially centrally located between any of one or more adjacent sides of the medication reminder card 10 and configured for the placement of one or more advertisements. The viewing surface of a third section 12C for can be configured for receiving messages to reinforce medication compliance. Between the first section 12A and the second section 12B is a first folding axis 14A. Between the section section 12B and the third section 12C is a second folding axis 14B. While the particular embodiment is illustrated with all three viewing surfaces of the first, second, and third sides 12A-C being of equal size, it is apparent that depending on the application of the visible means for advertising the one or more messages and reinforcing medication usage compliance, the size of each viewing surface may vary and can be differently arranged. For example, a particular advertising application may require that the viewing surface for the placement of one or more advertisements be given more space than the other two surfaces or that the order of the viewing surfaces is different. Additionally, while the particular embodiment illustrates three distinct viewing surfaces, the medication reminder card 10 can be arranged to eliminate any of the three or even add additional content on the card.

FIG. 1 further illustrates a scratch-off calendar 15 affixed to the medication reminder card 10. In another particular embodiment, the scratch-off calendar 15 is printed directly onto the reminder card and is substantially rectangular, though need not be limited to rectangular shapes. Each reminder card includes a single month, though depending on the particular application, the reminder card can be configured to include more or less than a single month, for example, for a prescription that is limited for a week or one that is for two-months. Each scratch-off calendar 15 includes the days of the month for the month being displayed on the reminder card. The scratch-off calendar 15 further incorporates a removable scratch-off coating 17 to hide printed symbols on each day of the month. The scratch-off coating 17 may be the kind of coating commonly used in the advertising and promotions industry and is used for example on lottery tickets to hide the winning numbers that match a published value in order to win an amount of money. The symbols hidden by the scratch-off coating 17 can be any symbol, of any shape, size or color that is useful for reinforcing medication usage compliance. In one preferred embodiment, the hidden symbols are checkmarks, one for each medication to be taken at the prescribed interval, for example, the scratch-off calendar comprises the month February with a checkmark symbol printed on the card but hidden by the scratch-off coating 17. However, in alternate embodiments of the present invention the scratch-off coating 17 itself can be any symbol, of any shape, size or color that is further useful for reinforcing medication usage compliance. Thus for example, the scratch-off coating 17 may be the color of purple, affixed to the scratch-off calendar 15 in the shape of the pill that is to be taken on that day, thus further visually reinforcing medication usage compliance (i.e. purple pill is taken every other day in February and thus is represented on the scratch-off calendar by a purple pill scratch-off).

Other preferred embodiments of the present invention include the medication reminder card 10 being formed with the front of the card being affixed to a magnetic back such that the card can be magnetically mounted to a compatible surface. Those skilled in the art will recognize that any other mounting apparatus can be used to affix the reminder card 10 to different surfaces. For example, the medication reminder card 10 can be two-holed punched and mounted on an apparatus appropriate for holding the medication reminder card 10.

In another particular embodiment the medication reminder card 10 is distributed by the pharmacy to a person taking the prescribed medication, but the card can be distributed directly by any care provider, including by way of example a hospital or doctor. The patient under a medication regimen takes the medication per the prescription and would scratch-off a corresponding scratch-off coated symbol on the medication reminder card 10. In doing so the patient is provided an opportunity to view the advertisement associated with the medication reminder card 10.

While one preferred embodiment refers to the use of the present invention by patients, other embodiments of the present invention provide that the medication reminder card 10 can be used for other applications that do not necessarily require a prescription, for example, the reminder card 10 could be used in vitamin-taking applications where no prescription is needed and the cards are distributed in a retail channel. Additionally, it is alternatively within the scope of the present invention to have a medication reminder card 10 not related in any way to the one or more advertisements associated with the card.

It is an advantage of one preferred embodiment of the present invention that because the medication reminder card 10 is a device that a user will review on a regimented basis, an advertisement associated with the reminder card will have a high review rate and thus lead to more successful advertisement results, which would include by way of example, increasing brand loyalty.

It is a further advantage of the particular embodiment of the present invention that the advertisement associated with the medication reminder card 10 can have a more targeted message based on the content of the medication or other product associated with the medication reminder card 10. For example, an application of the medication reminder card 10 includes diabetic medication to be taken three times daily and an associated targeted advertisement for blood-glucose measuring strips, a product generally required and highly related to the regimen of a diabetic. In another example, an application of the medication reminder card 10 includes non-prescription dietary supplements for a user increasing their iron in their blood via a pill to be taken daily and an associated target advertisement for Vitamin C in an orange juice product which Vitamin C aides in iron absorption. Thus, it is a further advantage of a preferred embodiment of the present invention that advertisers are able to highly target advertisements to relevant markets.

In other words, because the advertiser will be able to draw inferences about the consumer based on the prescription, the advertiser can advertise goods and services that are more likely to be of interest to that consumer. There are several possible examples. For example, if the prescription is for an osteo-arthritis or Alzheimer's disease medicine, then the target audience is probably older adults rather than children, and the advertiser can choose ad content accordingly. Conversely, some medicines are probably better correlated to young children, and in those cases the advertisers may choose to advertise goods and services relevant to such young children, or their parents. Of course, due care must be taken to observe all privacy regulations, to the extent, if any, that they might apply. This ability to target ads to the relevant audience is an advantage of a preferred embodiment of the present invention.

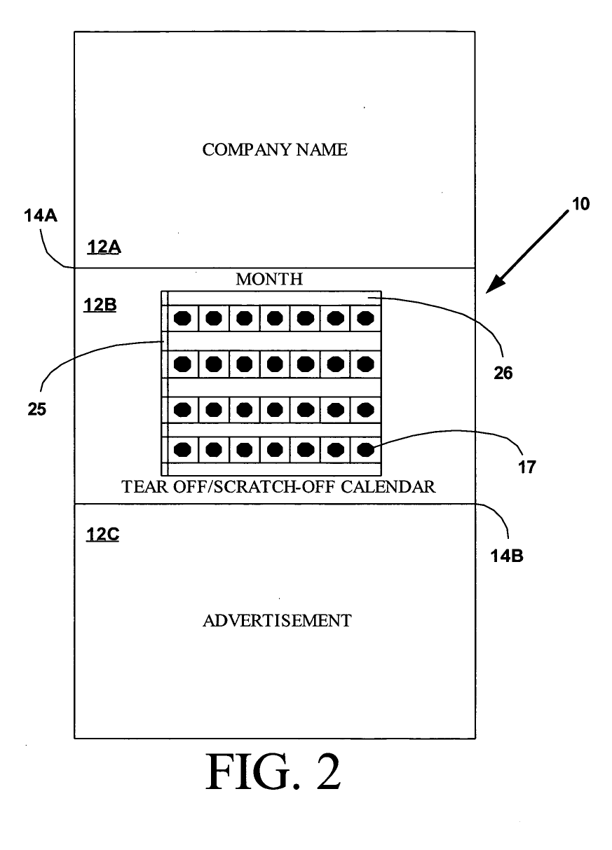

FIG. 2 illustrates an alternative embodiment of the present invention wherein a calendar pad 25 is affixed to the second section 12B of the medication reminder card 10. In FIG. 2 the scratch-off calendar pad 25 comprises a pad of paper sheets 26 or other means to identify each day and month of a year or other calendar time subdivision. Each sheet 26 is removably attached to the pad 25 which is further affixed to the medication reminder card 10, preferably in the viewing surface as illustrated but can be readily affixed to any viewable surface of the card.

Preferably, the calendar pad 25 further incorporates on one or more pages 26, calendar time subdivisions, one or more time subdivisions having a removable scratch-off coating 17 to hide printed symbols. Preferably the scratch-off coating 17 is the kind of coating commonly used in the advertising and promotions industry and is used for example on lottery tickets to hide the matching numbers to a publicized number in order to win an amount of money. The symbols hidden by the scratch-off coating 17 can be any symbol, of any shape, size or color that is useful for reinforcing medication usage compliance. In one embodiment the hidden symbols are checkmarks, one for each medication to be taken at the prescribed interval, for example, the calendar page comprises the Second day of February with three checkmark symbols printed on the card but hidden by the scratch-off coating. However, in alternate embodiments of the present invention, the scratch-off coating 17 itself can be any symbol, of any shape, size or color that is further useful for reinforcing medication usage compliance, and can include depicting a symbol in shape, size and/or color that is easily identifiable as the medication the user is to take. Thus for example, the scratch-off coating 27 may be the color of purple, affixed to the calendar page in the shape of the purple pill that is to be taken on that day, thus further visually reinforcing medication usage compliance. Not only does this enhance compliance, but also it allows particular drug manufacturers to further promote their brand.

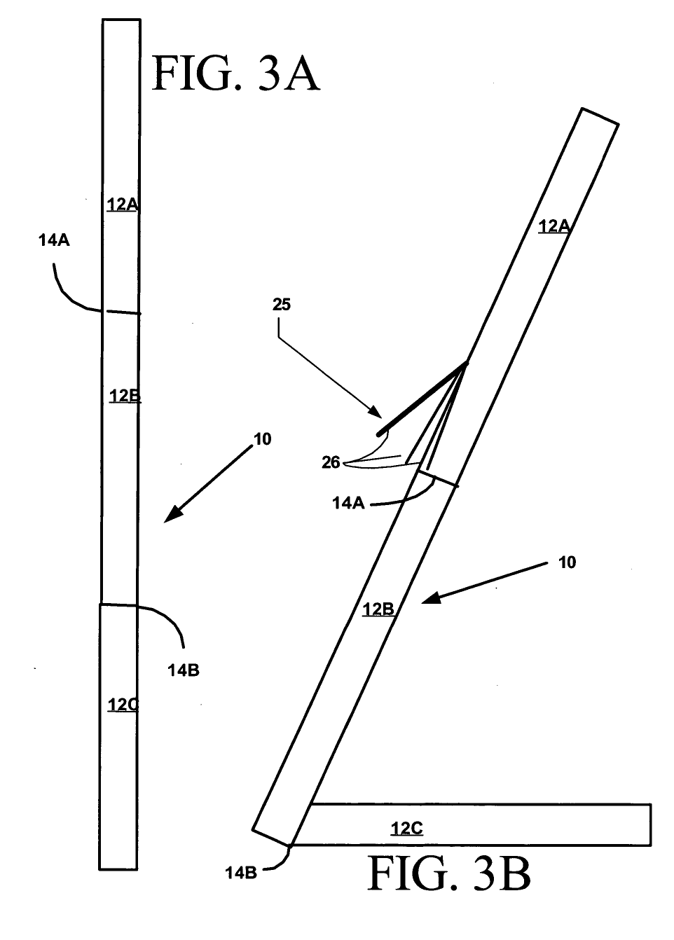

FIG. 3A and FIG. 3B illustrate yet another embodiment of the present invention, wherein in FIG. 3A the reminder card 10 is preferably fully extended but is formed to create visible means for advertising the one or more messages and reinforcing medication usage compliance includes a viewing surface on any of one or more sides of each first, second, or third sections 12A-C. In FIG. 3A sections 12A-C are linearly aligned in the medication reminder card 10 and provide viewing surfaces on each side of the sections 12A-C, thereby allowing for the placement of the name of the person or entity sponsoring or having affiliation with the advertisement, a viewing surface on any of one or more sides of the medication reminder card 10 for the placement of one or more advertisements, and a viewing surface on any of one or more sides of the medication reminder card 10 for the visible means to reinforce medication compliance.

In FIG. 3B, an alternative embodiment is shown wherein the third section 12C is sufficiently pliable to permit the folding about the second folding axis 14B to create a base so that the reminder card 10 is self-supporting or can be inserted in a supporting apparatus, for example a clear acrylic base. In this alternative embodiment, the calendar pad 25 is affixed to the first section 12A that is substantially linear with the second section 12B, establishing a visible means of reinforcing medication usage compliance. The calendar pad 25 is shown with several sheets 26 of the paper pad 25, each sheet including calendar time divisions and each time division having the scratch-off coating 17.

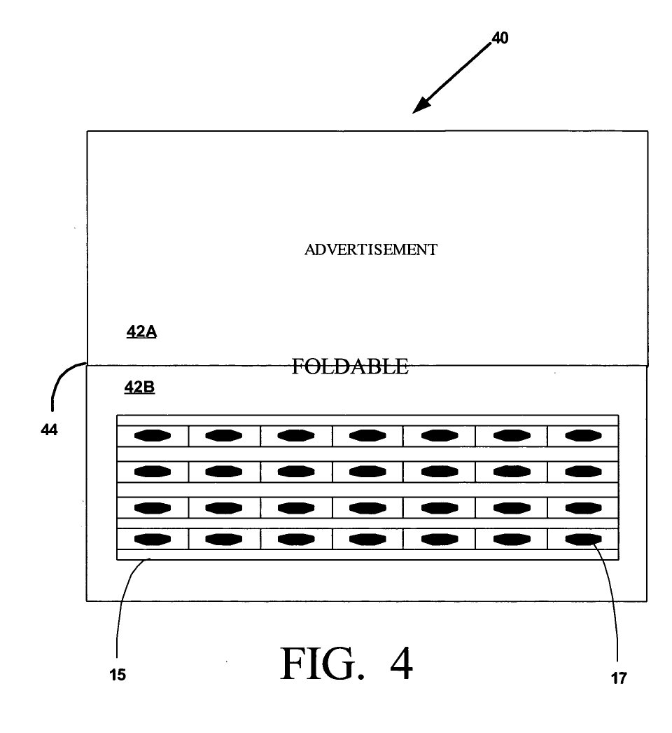

Depending on the embodiment, the medication reminder card 10 can be formed in any size to fit different distribution goals. For example, FIG. 4 illustrates another particular embodiment of the present invention wherein the medication reminder card 40 is formed to a size that fits into a wallet, purse or other carrying case. In this alternative embodiment, the visible means of reinforcing medication usage compliance is incorporated on a first section 42A of the card 40 and an advertisement is incorporated a second section 42B but can be incorporated to any visible surface on the first or second sections 42A or 42B. In this alternative embodiment, the visible means of reinforcing medication usage compliance can incorporate any of the foregoing methods, but preferably incorporates the scratch-off calendar 15 having the scratch-off coatings 17. Alternatively the card 40 may be configured to receive the calendar pad 25. Between the first and second sections 42A and 42B is a folding axis 44 to provide flexible pivoting or articulation between the sections.

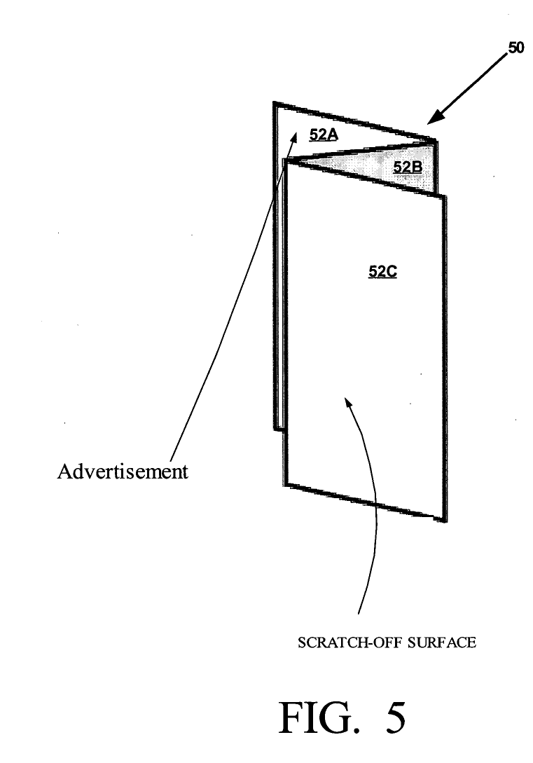

In yet another embodiment of the present invention, FIG. 5 illustrates a medication reminder card 50 having a first section 52A, a second section 52B, and a third section 52C in an accordion-styled configuration. The card 50 is printed with an advertisement on any available viewable surface of each section, in this example the first section 52A. As with the prior embodiments, preferably each side of each section can provide other viewable surfaces for receiving the medication reminders in the form of the scratch-offs calendar 25 or any other of the foregoing methods. While this embodiment is described as an accordion-styled card, those skilled in the art will perceive from this disclosure that the card can be folded in many other configurations and is not limited to three sections.

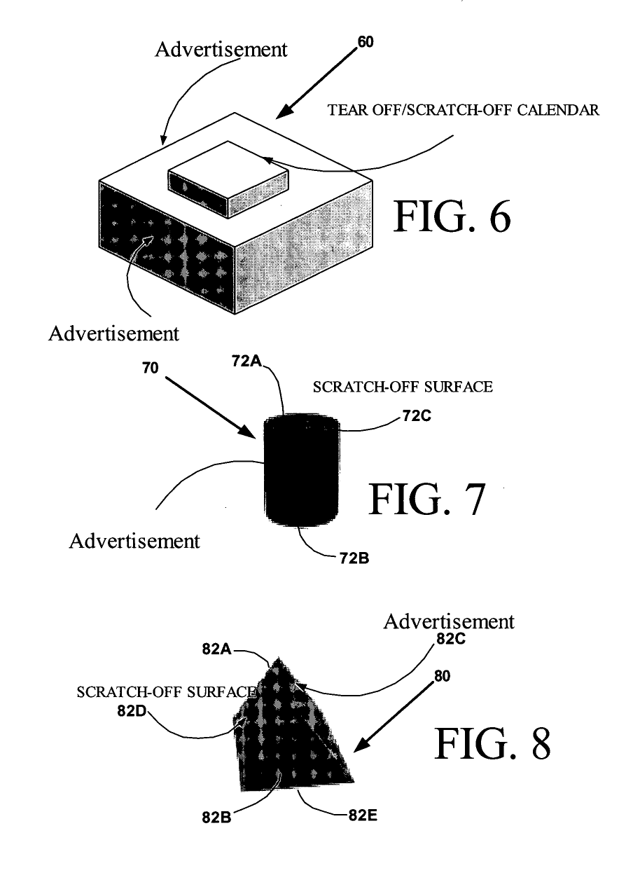

While the medication reminder card 10 has been described as generally a two-dimensional medium, those skilled in the art will recognize that any of the embodiments hereto described can be formed and made into three-dimensional objects capable of comprising one or more advertisement messages and being formed to create visible means for advertising the one or more messages and reinforcing medication usage compliance. FIGS. 6, 7, 8 illustrate alternative embodiments of the present invention wherein a third-dimension to the medication reminder card 10 is added. An advantage of this embodiment is that there exist more viewable surfaces and thus an opportunity to include more than one advertisement.

For example, FIG. 6 illustrates a cubed-shaped medication reminder card 60 that provides multiple surfaces to receive messages. In this alternative embodiment, the visible means of reinforcing medication usage compliance can incorporate any of the foregoing methods, for example the scratch-off calendar 25. Similarly, FIG. 7 illustrates another alternate embodiment of a cylindrical-shaped medication reminder card 70 that provides two circular surfaces 72A and 72B at the end of the cylinder card 70 and the circumferential surface 72C to receive messages or the scratch-off calendar 15 or calendar pad 25. FIG. 8 illustrates another alternate embodiment of a pyramidal or triangular-shaped medication reminder card 80 that provides two triangular sides 82A and 82B at the end the pyramid and three pyramid bases (82C-E), each surface side or base configured to receive messages or the scratch-off calendar 25.

While the particular embodiment of the invention has been illustrated and described, as noted above, many changes can be made without departing from the spirit and scope of the invention. For example, FIGS. 9, 10, 11 and 12 illustrate alternate embodiments of the calendar 25 having different shapes, colors, and numbers of the removable scratch-off coating 17 applied to the time sub-divisions of the calendar 25.

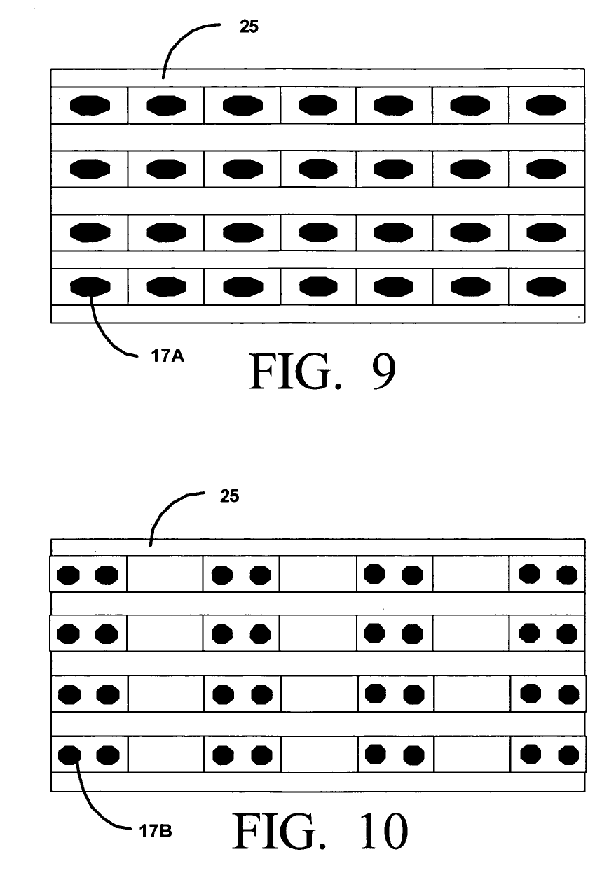

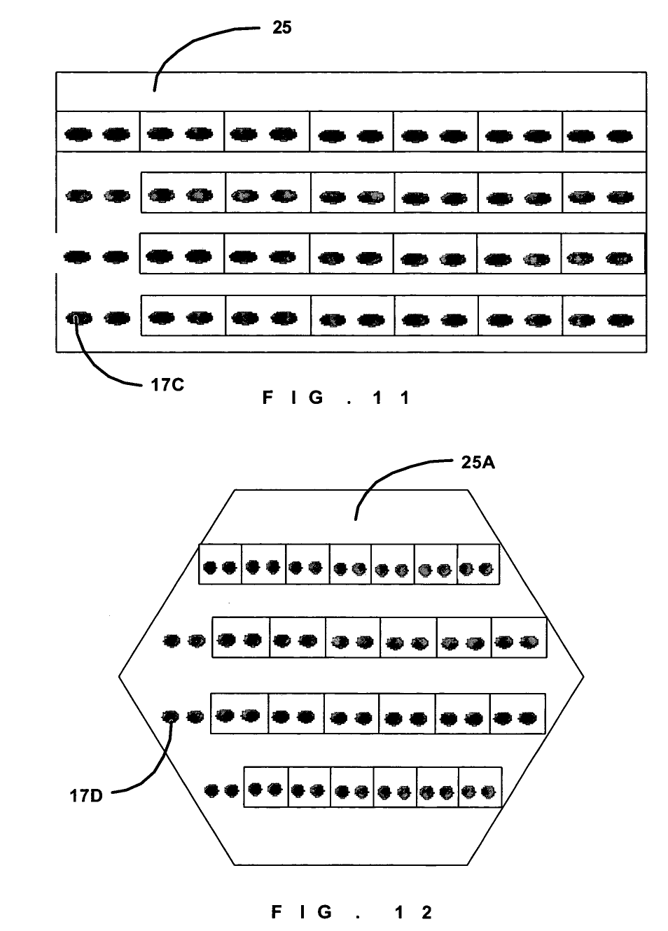

In FIG. 9, the calendar 25 includes a single octagonal-shaped removable scratch-off coating 17A. In FIG. 10, the calendar 25 includes a pair of single octagonal-shaped removable scratch-off coatings 17B. In FIG. 11, the calendar 25 includes a pair of oval-shaped removable scratch-off coatings 17C. The oval-shaped coatings 17B may be differently colored, for example orange and purple to reflect different kinds of medications. In FIG. 12, a calendar pad 25A is substantially hexagon-shaped and includes a pair of substantially circular-shaped removable scratch-off coatings 17D. Another alternate embodiment of the scratch-off coating 17 would include mixtures of two or more shapes and/or colors. For example, a given calendar time division could have an octagon coating 17A colored red and an oval-shaped coating 17C colored green.

Presently preferred embodiments include scratch-off symbols that vary by shape, color, number or any other variable, or any combination of the foregoing. In some embodiments, the means of reinforcing medication usage compliance may be configured to medical based and non-medical based regimens. For example, other removable material may be used instead of the scratch-off coatings 17A-D. For example, peel-off stickers or peel-off coatings may be substituted. Another example for the scratch-off coatings 17A-D and peel-off stickers would be numbers overlaid or printed on the coatings and stickers to further provide other visible and information-based minders for medical and non-medical reminder uses. The numbers could be configured for marking-off with a writing device as a means for verifying compliance with the medication or non-medical routine. In such a case, the material need not be removable for receiving check-off marks or other indicia of compliance.

In a particular embodiment, the advertisers may choose which particular device or combination of devices they would like to use for their advertisement, and distribute these to the pharmacy to distribute to the consumers in whichever form the particular consumer would prefer. Preferably, the advertiser provides the pharmacy distribution chain with every kind of device described in this application, to maximize the choices available to the consumer, thereby maximizing probability of compliance and advertising retention.

While the particular embodiments of the invention have been illustrated and described, as noted above, many changes can be made without departing from the spirit and scope of the invention. For example, the sections that receive the advertising messages and calendars may have a variety of shapes. The shapes may include octagonal, rectangular, square, triangular, diamond, circle, oval, cylindrical, spherical, dome, pyramidal, box, and parabolic or cup-like.

Another alternate embodiment would allow multiple regimens to be covered by or associated with a single calendar. For example, the modifiable material of the calendar's time-based divisions would have multiple regions. Each region of the time-based material could be dedicated or otherwise associated with a different regimen. In this case an upper region of the time-based division would be associated with encouraging development of a health habit (or the incremental cessation of a bad health habit), and the lower region of time-based division would concern discipline training exercises. Incremental progress toward eventual complete compliance to a given regimen would be documented by the user's modification of the modifiable material contained within each upper or lower (or side-by-side) region. The modification of each region would be as taught above, and may be differentially shape or color-coded. Moreover, the kind of modifiable material within a region may be different from the modifiable material of the other region (a scratch off region vs. a peel off region).

Accordingly, as described above, the scope of the invention is not limited by the disclosure of the particular embodiments. Instead, the invention should be determined entirely by reference to the claims that follow.

1. A system to deliver advertising, comprising:
a first section having a surface with an advertising message in view of a user;
a calendar having time-based divisions configured to remind the user to comply with a regimen, the time-base divisions further having modifiable material; and
a second section having a surface to receive the calendar and in view of the user with the first section,
whereupon advertising of the first section is viewed by the user and regimen compliance is confirmed by the user's modification of the modifiable material.

2. The system of claim 1 wherein the modifiable material of the time-based divisions is modifiable by the actions selected from the group consisting of marking upon, scratching, punching out, and peeling off the modifiable material.

3. The system of claim 1 wherein the modifiable material is color-coded.

4. The system of claim 3 wherein more than one color is conferred to the modifiable material.

5. The system of claim 1 wherein the modifiable material is shaped-coded.

6. The system of claim 5 wherein the shapes are selected from the group consisting of octagonal, rectangular, square, diamond, circle, and oval.

7. The system of claim 6 wherein more than one shape is conferred to the modifiable material.

8. The system of claim 1, wherein the first and section sections articulate about a foldable axis.

9. The system of claim 1, wherein the first and sections further have shapes selected from the group consisting of parabolic, octagonal, rectangular, triangular, square, diamond, circle, oval, cylindrical, spherical, pyramidal, dome, and box.

10. A method to deliver advertising, comprising:
applying an advertising message to a first section having a surface with an advertising message in view of a user;
affixing a calendar to a second section attached to the first section, the calendar having time-based divisions configured to remind the user to comply with a regimen, the time-base divisions further having modifiable material; and
modifying the modifiable material,
whereupon the advertising message of the first section is viewed by the user and regimen compliance is confirmed by the user's modification of the modifiable material. The system of claim 10 wherein the shapes are selected from the group consisting of octagonal, rectangular, square, diamond, circle, and oval.

11. The method of claim 10, wherein modifying the modifiable material further includes scratching, punching out, marking upon, removing regions of, and peeling off the modifiable material.

12. An advertising device, comprising:
a surface to receive at least one advertising message in view of a user;
at least one calendar affixable to the surface, the calendar further having time-based divisions configured to remind the user to comply with a regimen, the time-base divisions further having modifiable material,
whereupon information from the advertising message is viewed by the user and regimen compliance is confirmed by the user's modification of the modifiable material.

13. The device of claim 12, wherein the surface comprises a first section and a second section, the first section having a first advertising message and the second section having a second advertising message.

14. The device of claim 13, wherein the at least one calendar includes a first calendar affixed to the first section and a second calendar affixed to the second section.

15. The device of claim 14, wherein the regimen further includes a first regimen associated with the first calendar and a second regimen associated with the second calendar.

16. The device of claim 12, wherein the shapes of the time-based divisions are selected from the group consisting of octagonal, rectangular, square, diamond, circle, and oval.

17. The device of claim 16, wherein the modifiable material of the time-based divisions is modifiable by the actions selected from the group consisting of marking upon, scratching, punching out, and peeling off the modifiable material.

18. The device of claim 17, wherein the modifiable material is color coded.

19. The device of claim 13, wherein the first and second sections have shapes selected from the group consisting of octagonal, triangular, rectangular, square, diamond, circle, oval, cylindrical, spherical, pyramidal, dome, and box.

20. The device of claim 19, wherein the first and second sections include an axis configured to pivot the first section relative to the second section.

21. The device of claim 12, wherein the regimen further includes a plurality of regimens.

22. The device of claim 21, wherein the modifiable material of the time based divisions further includes a plurality of regions to associate with the plurality of regimens.
